(19) United States
(12) Patent Application Publication
(10) Pub. No.: US 2008/0034520 A1
(43) Pub. Date: Feb. 14, 2008

(54) CLEANING DEVICE FOR GOLF EQUIPMENT

(76) Inventor: Aaron Heap, Salt Lake City, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/780,455

(22) Filed: Jul. 19, 2007

Related U.S. Application Data
(60) Provisional application No. 60/820,089, filed on Jul. 21, 2006.
(60) Provisional application No. 60/885,188, filed on Jan. 16, 2007.

(51) Int. Cl. A46B 11/00; A46B 15/00; B08B 3/02; B08B 3/04; B08B 3/10

(52) U.S. Cl. 15/105; 134/184; 134/198; 134/201; 15/159.1

(57) ABSTRACT

The present invention relates to apparatus and assemblies for cleaning golf equipment, such as a golf ball or golf club. A fluid reservoir stores a quantity of pressurized fluid, and has a release that can selectively release cleaning fluid therefrom. A regulator is coupled with the release and is adapted to limit the amount of cleaning fluid released from the reservoir in a single engagement of the release, so that only a predetermined, maximum amount of cleaning fluid, that is less than the quantity of the cleaning fluid stored in the reservoir, is released. Upon engaging the release, the fluid can be discharged into an enclosed chamber. The chamber is filled with the predetermined amount of fluid and, when the predetermined amount of fluid is present in the chamber, additional fluid is blocked from the fluid reservoir. Thereafter, upon disengagement of the release, the fluid is dispensed to ambient.

### RELATED PATENT APPLICATIONS

This patent application claims the benefit of, and priority to, U.S. Provisional Patent Application Ser. No. 60/820,089, entitled “GOLF CLUB AND GOLF BALL CLEANING DEVICE,” filed on Jul. 21, 2006, U.S. Provisional Patent Application Ser. No. 60/885,188, entitled “GOLF CLUB AND GOLF BALL CLEANING DEVICE,” filed on Jan. 16, 2007, and U.S. Design Patent Application Ser. No. 29/279,609, entitled “GOLF CLUB AND GOLF BALL CLEANING DEVICE,” filed May 3, 2007, each of which are hereby expressly incorporated by reference in their entireties.

### BACKGROUND OF THE INVENTION

1. The Field of the Invention

Exemplary embodiments of the invention relate to the field cleaning devices and assemblies. More particularly, exemplary embodiments of the invention relate to devices and assemblies for cleaning golf equipment such as golf balls and golf clubs.

2. The Relevant Technology

Golf ball manufacturers have gone to great lengths to improve the aerodynamic properties of golf balls by using specific covering materials and dimpled surface patterns. As a golfer places such a ball in play, the environment of the golf course often causes the outer surface of the ball, and particularly the dimples, to accumulate grass, mud, dirt and other debris. When such materials collect on the ball, they can affect the flight of the ball, thereby making the flight of the ball unpredictable. Similarly, when a golfer is putting, the materials can affect the ball's roll, thereby causing the golfer to miss an otherwise perfectly judged putt. In either case, the unpredictable nature of the ball's flight or roll can hinder the golfer's ability to shoot a low score.

While playing on the golf course, the golfer may have difficulty cleaning the golf ball inasmuch as many golf courses don't have golf ball cleaning devices. Others may have ball cleaning devices spaced around the course, but the golfer is not guaranteed to find a cleaner at the location needed. For example, golf ball cleaners on a golf course are sometimes found near the tee boxes, but are rarely found near the green.

The golf industry has also dedicated many resources to improving golf clubs in terms of both distance and spin. Each of these can be affected, to one degree or another, by grooves placed in the head of the golf club. For example, deep grooves may be formed in the golf club head so as to increase the amount of spin a golfer is able to place on a well struck golf ball, thereby allowing the golfer to increase the distance control on the club.

The environment of the golf course can also cause the head of a golf club to accumulate grass, mud, dirt, or other debris. In particular, these materials may accumulate on the head of the golf club, and particularly within the grooves on the golf club head, thereby decreasing the desired depth of the groove and otherwise reducing the designed-for benefits of the club.

Similar to what the golfer finds with a golf ball, the golfer may have difficulty cleaning the golf club while on the course inasmuch as many golf courses don't have golf club cleaning devices. Indeed, golf club cleaners are often found on a course even less frequently than golf ball cleaners.

When the golfer does find a golf ball or golf club cleaner, the golfer may not obtain the amount of cleaning desired, or may spend more time than necessary cleaning the golf club or golf ball. For example, the golfer may insert the ball or golf club into a cleaner for less time than necessary because the user is unsure of what amount of cleaner and/or brushing will be necessary to clean the ball or club. In such case, the golfer can extract the ball or club and may find that it still has debris accumulated thereon. If the ball and club are not fully cleaned, the ball's flight and/or roll may continue to be affected, and/or the golfer may have difficulty controlling the ball. Thus, to fully clean the ball or club, the golfer may duplicate his or her efforts, thereby taking additional time which may slow the speed of the game. In contrast, because the golfer does not know the optimal amount of fluid or time necessary to clean the ball or club, the golfer may take more time than necessary, thereby wasting much of the golfer's efforts, and also slowing down the speed of the game.

Accordingly, what are desired are easy-to-use apparatus and assemblies which provide a golfer a way to quickly and efficiently clean a golf ball and/or golf club, and which deliver just the right amount of cleanser for cleaning the golf ball and/or golf club.

### BRIEF SUMMARY OF THE INVENTION

Exemplary embodiments of the invention relate to cleaning devices and cleaning assemblies. Some exemplary cleaning devices and assemblies can be configured for use with golfing equipment, such as golf balls and golf clubs, thereby allowing golfers to keep their equipment clean while at home or on the course, and further improving the consistency of the user and the longevity of the equipment. Exemplary cleaning devices of the system can include a fluid reservoir and a valve placed in fluid communication with the fluid reservoir. The valve can be adapted such that it releases cleaning fluid contained within the fluid reservoir when the valve is engaged. A regulator may further be coupled to the valve such that a predetermined amount of cleaning fluid is dispensed with a single engagement of the valve. The cleaning device may also include an agitator, such as a brush, which can be used to remove materials from the object onto which the cleaning fluid is dispensed. The brush may be selectively removable, and different brushes can be used for different equipment.

According to one embodiment of the present invention, a device for cleaning golf equipment includes a reservoir storing a quantity of cleaning fluid. The reservoir includes a selectively engageable release that releases cleaning fluid from the reservoir. A regulator may be coupled with the release, and can limit the amount of cleaning fluid released from the reservoir in a single engagement of the release. The amount may be, for example, limited to a predetermined amount of cleaning fluid that is less than the quantity of cleaning fluid stored in the reservoir. For example, the regulator can include a chamber that receives cleaning fluid released from the reservoir. As the fluid is released, and before it is dispensed into the environment or onto an object, the cleaning fluid may be temporarily stored within the chamber. The size of the chamber may be such that it contains only the predetermined amount of cleaning fluid. The chamber can optionally be sealed so that even when the release continues to be engaged, only the predetermined amount of fluid is released. Then, when the release is disengaged, the cleaning fluid can be dispensed on to a desired object.

In another embodiment of the present invention, an assembly for cleaning a golf ball includes a reservoir storing pressurized cleaning fluid and having a valve for releasing the pressurized fluid. A trigger is coupled to the valve such that when the trigger is engaged, the valve releases the pressurized fluid from the reservoir. A mechanism for dispensing a predetermined amount of cleaning fluid is also included and, when the trigger causes release of the pressurized cleaning fluid, an enclosed chamber within the mechanism, and external to the reservoir, receives up to the predetermined amount of cleaning fluid. The amount of fluid contained can vary as desired. In one example, for instance, the amount of fluid may range from about 2 milliliters (ml) to about 5 ml. Optionally, the assembly may also be configures such that the predetermined amount of fluid is selectively changeable. For instance, different predetermined amounts may be used when cleaning a golf ball as compared to a golf club. The assembly can further include a cleaning brush and/or a detachable cap. The integral cleaning brush may further be contoured to compliment the contour of the outer surface of a golf ball.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope, nor are the drawings necessarily drawn to scale. The invention will be described and explained with additional specificity and detail through the use of the accompanying drawings in which:

FIG. 1 is an exploded perspective view of an exemplary cleaning device for golf equipment having a fluid reservoir, trigger assembly, agitator, and cap, according to one embodiment of the present invention;

FIG. 2 is a front, elevational view of the cleaning device of FIG. 1, with the cap installed and enclosing the trigger assembly;

FIG. 3 is a bottom, plan view of the cleaning device of FIGS. 1 and 2, further illustrating the agitator;

FIG. 4 is a cut-away view of an example agitator, the agitator having bristles in a flat configuration;

FIG. 5 is a cut-away view of an alternative example agitator, the agitator having bristles in an exemplary contoured configuration;

FIG. 6 is an exploded, front elevational view of another exemplary cleaning device, according to an alternative embodiment of the present invention;

FIG. 7 is a perspective view of the exemplary cleaning device of FIG. 6, in which the dispensing button has been removed; and

FIG. 8 a bottom, plan view of the dispensing button of FIG. 6.

### DETAILED DESCRIPTION OF THE PREFERRED EMBODIMENTS

Exemplary embodiments of the invention relate to cleaning devices and cleaning assemblies, and particularly to hand-held or portable cleaning apparatus. A cleaning device or assembly, as disclosed herein, can include a fluid reservoir in which cleaning fluid is stored, and optionally stored under pressure. A trigger assembly is coupled to the fluid reservoir to dispense the cleaning fluid from the reservoir, and an agitator, such as a brush, can be further include to facilitate cleaning of an object on which the cleaning fluid is dispensed. In some embodiments, the trigger assembly may further be configured to act a regulator, and meter the dispensed fluid so that each time the trigger assembly is engaged, a predetermined amount of cleaning fluid is dispensed for cleaning.

Reference will now be made to the drawings to describe various aspects of exemplary embodiments of the invention. It is understood that the drawings are diagrammatic and schematic representations of such exemplary embodiments, and are not limiting of the present invention, nor are they necessarily drawn to scale. No inference should therefore be drawn from the drawings as to the required dimensions of any invention or element. In the following description, numerous specific details are set forth in order to provide a thorough understanding of the present invention. It will be obvious, however, to one of ordinary skill in the art that the present invention may be practiced without these specific details.

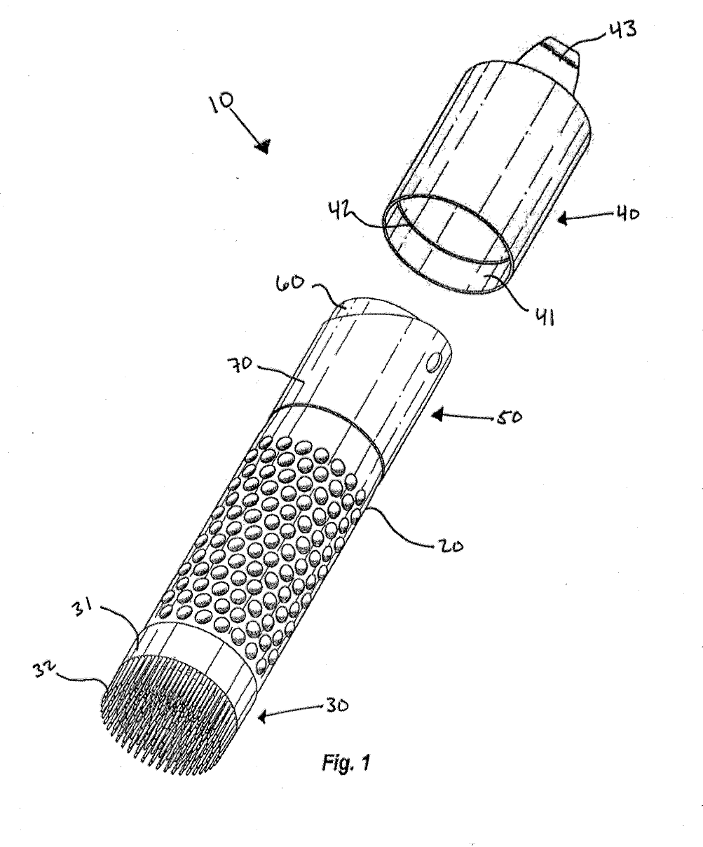

FIGS. 1-3 illustrate an exemplary embodiment of a cleaning device according to one embodiment of the present invention. In particular, FIGS. 1-3 illustrate an exemplary cleaning device 10 which can be used to clean golf balls and golf clubs, thereby allowing a golfer to maintain properly cleaned equipment that is more consistent and has a longer useful life.

As illustrated in FIG. 1, a cleaning device 10 can include, according to one exemplary embodiment, a fluid reservoir 20 which is configured to store cleaning fluid therein. According to one embodiment, fluid reservoir 20 stores a cleaning fluid in a pressurized state. Such storage of the cleaning fluid can be desirable for a variety of reasons. For example, in embodiments in which the cleaning fluid is compressible, pressurizing the fluid can compress the cleaning fluid into fluid reservoir 20 such that a greater quantity of fluid may be stored in fluid reservoir 20. Additionally, by storing the cleaning fluid 20 under pressure, a release mechanism (not shown) can be simplified. For example, as described elsewhere herein, by opening an aperture in fluid reservoir 20, a pressure differential is formed which allows the pressurized cleaning fluid to naturally flow out of such an opening. The natural movement can facilitate a release mechanism which could otherwise, require additional pumps or other mechanisms to create a pressure differential necessary to extract non-pressurized fluid. While fluid reservoir 20 keeps cleaning fluid under pressure in one embodiment of the present invention, it will be appreciated that this is not necessary. Indeed, it is contemplated that in other embodiments, cleaning fluid within fluid reservoir 20 is not pressurized, and is extracted by other means.

The release of the cleaning fluid from fluid reservoir 20, whether such fluid is kept in a pressurized or non-pressurized state, can be facilitated by the use of a triggering mechanism 50, which is coupled to fluid reservoir 20, and in fluid communication with the cleaning fluid therein. By way of example, and not limitation, triggering mechanism 50 can include, as illustrated in FIG. 1, a dispensing button 60 and a spray tip 70. Dispensing button 60 is configured to be selectively engageable to trigger the release of the cleaning fluid from within fluid reservoir 20. For example, according to one embodiment, dispensing button 60 is biased such that it a neutral state, no fluid is being released from reservoir 20. When a user subsequently depresses dispensing button 60, the user can overcome the biasing force to engage a release valve linked to fluid reservoir 20.

Engagement dispensing button 60 by depression or other means may thusly cause fluid to be released from fluid reservoir 20. Dispensing button 60 may be placed in fluid communication with the fluid in fluid reservoir 20 such that as the cleaning fluid is released from fluid reservoir 20, the fluid can flow through a channel (not shown) in dispensing button 60, and toward outlet (not shown) in dispensing button 60. The outlet in dispensing button 60 optionally aligns with an aperture 71 in spray tip 70. The cleaning fluid can then pass through aperture 71 in spray tip 70, where it is dispensed into the ambient. For example, the cleaning fluid may be dispensed onto a golf ball, golf club, or other golf-related equipment, or even onto non-golf related objects.

It should be appreciated in view of the disclosure herein that any suitable cleaning fluid may be stored within fluid reservoir 20 and dispensed in a similar manner. For example, according to one embodiment, the contents of fluid reservoir 20 include a simple soap and/or water. It will be appreciated, however, that more specialized mixtures may also be used, including mixtures with cleaning agents directed to grass and dirt. For instance, a suitable cleaning fluid may include, one or more of water, soap propylene glycol, ammonia, vinegar, bleach, borax, silicon (including water soluble silicone), sodium lauryl sarcosinate, imidazoline, and/or sodium pyrrolidine carboxylate. In some embodiments, carbon dioxide or another pressurized gas may be stored within fluid reservoir 20, along with, or separate from, a cleaning fluid.

It will be appreciated that these components and examples are merely representative and that any number of other suitable compositions can be stored individually or collectively within fluid reservoir 20. Moreover, according to one embodiment, components are combined so that when the fluid is dispensed into the ambient, the cleaning fluid produces a cleaning foam on the object to be cleaned.

As described herein, the pressurized contents of fluid reservoir 20 can thus be easily and efficiently released from fluid reservoir 20 and dispensed onto the surface of a desired object, such as a golf ball or golf club for cleaning. The use of the fluid mixture on the object can increase the effectiveness of cleaning since the fluid mixture is able to loosen the grass, mud, dirt, or other types of debris.

Once the user has placed the cleaning fluid and/or foam on the desired object, the user can take a towel or other suitable material to wipe the surface of the object and remove any loosened dirt, grass, or debris from the surface of the object. In some embodiments, an agitator, such as a brush, may also be used to assist in applying the cleaning fluid and/or foam to the entire surface of the object to be cleaned, and to help in further loosening the grass, dirt or other debris on the object.

As illustrated in FIG. 1, an agitator 30 may be connected to the cleaning device assembly 10, such that it operates as an integral component thereof. For example, in the illustrated embodiment, agitator 30 includes a sleeve 31 which engages the outer surface of the bottom portion of fluid reservoir 20. Sleeve 31 may be securely coupled thereto and/or removably coupled to fluid reservoir 20. For instance, in one embodiment, sleeve 31 may have a thread profile (not shown) on its internal surface, to allow sleeve 31 to be threaded onto the bottom portion of fluid reservoir 20, which may have a corresponding thread profile. In another embodiment, sleeve 31 is formed of a flexible material, such as plastic, and frictionally engages fluid reservoir 20. For instance, an interference fit may be formed as sleeve 31 is placed around the outer surface of fluid reservoir. Optionally, one or more ridges may be formed on the inner surface of sleeve 31 to facilitate such an interference fit. In still other embodiments, agitator 30 may not be selectively connectable to fluid reservoir 20 and may instead be at least partially integrally formed therewith, or otherwise permanently attached thereto.

While the illustrated embodiment illustrates agitator 30 coupled to the bottom portion of fluid reservoir 20, and triggering mechanism 50 coupled to an upper portion of fluid reservoir 20, it should be appreciated that this embodiment is for illustrative purposes only, and is not necessarily limiting of the present invention. Indeed, other embodiments are contemplated in which the triggering mechanism is integrated within the agitator.

After the user has applied the cleaning fluid and/or foam to the surface of the object to be cleaned, the surface of the object is placed against the cleaning portion of agitator 30. In the illustrated embodiment, in which agitator 30 is a brush, agitator 30 includes a plurality of flexible bristles 32, which flex as they pass along the surface of the object being cleaned, and which loosen any debris on that surface. After bristles 32 work in connection with the cleaning fluid to clean the surface of the object the object can then optionally be dried with a towel or in another suitable manner.

Agitator 30 may have any suitable shape and configuration. For example, as shown in FIG. 3, agitator 30 has a generally circular configuration, and bristles 32 are arranged in a generally spiral configuration. In other embodiments, however, bristles 32 may have any other suitable configuration and/or agitator 30 may have another shape, and may be generally square, rectangular, triangular, diamond-shaped, or have any other desired shape.

As shown in FIG. 4, which illustrates a cut-away view of the center of an agitator 30a, the bristles 32a may have a generally straight configuration. In particular, in the illustrated embodiment, each of the bristles are about the same length and align in along a generally straight line at their distal and proximal ends. In other embodiments, such as that shown in FIG. 5, an agitator 30b may have bristles 32b in another configuration. For example, in the illustrated embodiment, distal ends of bristles 32b collectively and gradually contour inward, towards the center of agitator 30b. Such a contoured configuration may be desirable for a variety of reasons. For example, bristles 32b may be configured to compliment the shame and/or size of the object being cleaned. Where the object being cleaned is a golf ball, for example, the contour of bristles 32b may approximately match the shape of the golf ball. Consequently, when the golf ball is being cleaned, the golf ball can partially reside within the contoured bristles 32b of agitator 30b. In some embodiments, the contoured bristles 32b form a receiving portion in which the outer perimeter forms a side barrier that reduces the golf ball's ability to roll of the sides of agitator 30b when the golf ball is within the receiving portion. An agitator may also be contoured in any other suitable manner. For instance, in one embodiment, the portion of the agitator receiving an object may be inclined at a particular angle, across all or any portion of the width of the agitator. The incline may be, for example, a straight incline or a parabolic incline configured to match the shape of a golf club.

Returning now to FIG. 1, it will be appreciated in view of the disclosure herein that agitator 30 can be made of any of a number of suitable materials. For instance, as noted previously, sleeve 31 of agitator 30 may be formed of a flexible plastic material. Optionally, bristles 32 are formed of the same material as sleeve 31. Accordingly, in one embodiment, bristles 32 may be formed of a plastic, such as nylon. In another embodiment, bristles 32 are formed of metal wire, such as copper or steel. In such an embodiment, sleeve 31 can be formed of the same metal, or may be formed of a different metal or material. In other embodiments, bristles 32 may be formed of horsehair, straw, or another suitable material.

The material used for bristles 32 may be selected based on the object which is to be cleaned with cleaning device 10. For example, nylon, straw, or horsehair bristles may be desirable for in cleaning a golf ball, whereas steel or copper may be desirable for a golf club. Of course, inasmuch as the invention disclosed herein is not limited to use with golf balls and golf clubs, but may be used with any other golf or non-golf equipment or objects, other materials may also be desirable for bristles 32.

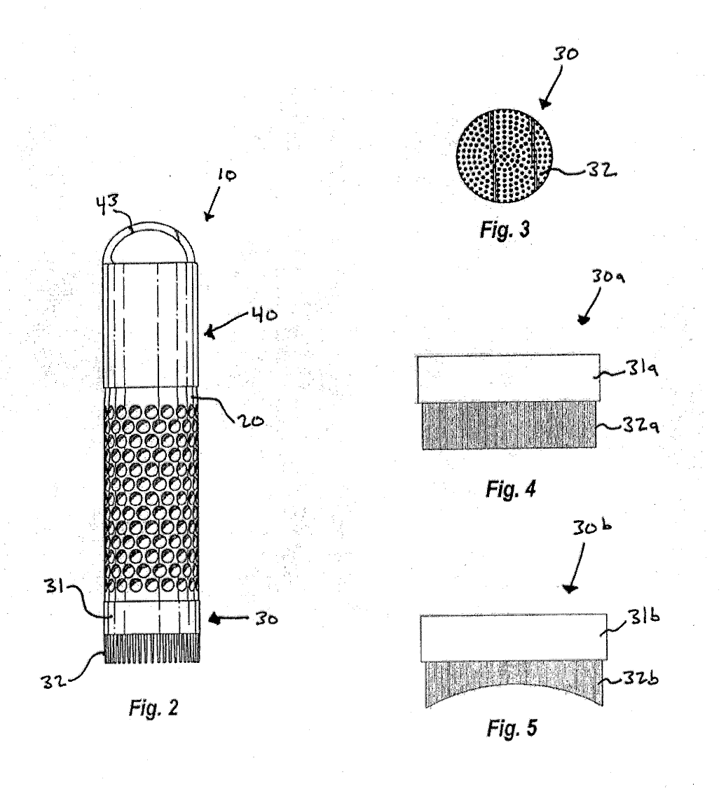

Furthermore, as disclosed herein, agitator 30 may be selectively removable. Consequently cleaning device 10 may have a modular configuration that allows a user to change agitators based on the device to be cleaned, and/or to replace an agitator as needed. For example, a user may pull off agitator 30 illustrated in FIG. 2, and replace it with another agitator which may be more suited for cleaning another object.

With reference to FIGS. 1 and 2, and as disclosed herein, in some embodiments, a cleaning device 10 according to the present invention can include a cap 40 which at least partially encloses triggering mechanism 50. In particular, in the illustrated embodiment, cap 40 can be selectively detached from triggering mechanism 50, as shown in FIG. 1, to expose triggering system 50 and allow a user to dispense a cleaning fluid. Alternatively, as shown in FIG. 2, cap 40 can be selectively secured to triggering system 50, and can at least partially enclose triggering system 50 therein, thereby preventing a user from engaging triggering system 50 and reducing the chance that a user will inadvertently dispense cleaning fluid from reservoir 20.

Cap 40 may also be adapted to be selectively and securely fastened to triggering mechanism 50. For example, cap 40 may have threads (not shown) which mate with corresponding threads on triggering mechanism 50 or fluid reservoir 20. Alternatively, other securement mechanisms may be utilized. For example, as shown in FIG. 1, a ridge 42 can formed on the interior surface 41 of cap 40. As a user presses cap 40 over triggering mechanism 50, ridge 42 creates an interference or frictional fit which releasably and securely fastens cap 40 to triggering mechanism 50 and fluid reservoir 20. Such a friction fit can thus lessen the likelihood that cap 40 will become inadvertently dislodged during normal use and/or play. Different levels of strength for the friction fit may be considered to be contemplated within the scope of the present invention. Moreover, other connection mechanisms may be employed. For example, a clasp or buckle may be used and a tether between triggering mechanism 50 and cap 40 may optionally be utilized

Cap 40 may have any desired configuration, and no particular configuration should be considered limiting of the present invention. In particular, in the illustrated embodiment, cap 40 has a generally cylindrical configuration and has a clip 43 coupled thereto. Clip 43 can facilitate handling of cap 40, and removal of cap 40 from triggering mechanism 50. Additionally, clip 43 can allow a user to easily attach cleaning device 10 to a desired location, such as a golf bag, for convenient access and storage. In one embodiment, one side of clip 43 (e.g., the left side of clip 43 in FIG. 2), may be selectively releasable so that an opening can be formed to allow clip 43 to be quickly attached to a desired location. In one embodiment, clip 43 is integrally formed in cap 40, although this feature is not necessary, and clip 43 may be a discrete component in other embodiments.

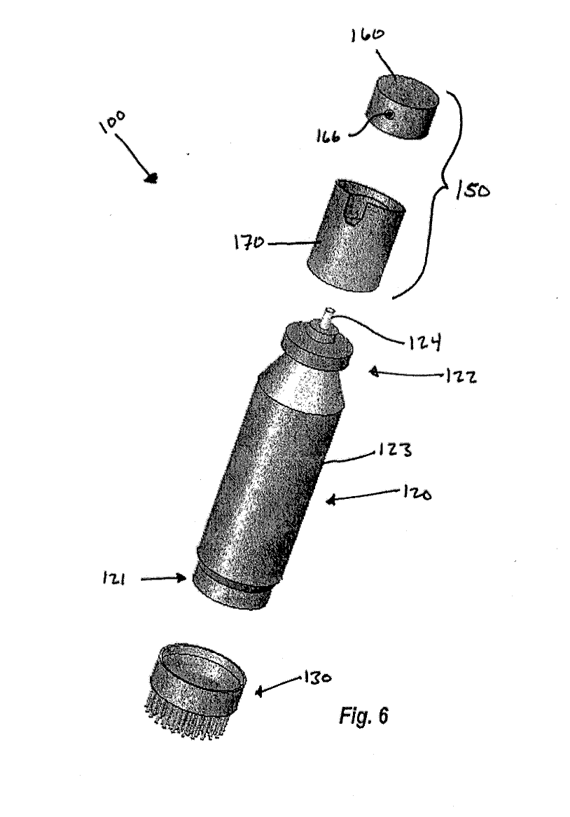

Now referring to FIGS. 6-8, an alternative embodiment of a cleaning device 100 is illustrated according to another embodiment of the present invention. The device and assembly of the alternative embodiment is functionally similar to that of the device previously disclosed above, and shown in FIGS. 1-5, in most respects, wherein certain features will not be described in relation to the alternative embodiments wherein those components function in the manner as described above, and are hereby incorporated into the alternative embodiment described below.

FIG. 6 illustrates an exploded view of an exemplary cleaning device 100. Cleaning device includes, in this example, a fluid reservoir 120, which may be a cartridge containing a pressurized gas and/or cleaning liquid. Fluid reservoir 120 is configured to attach to an agitator 130 which couples with fluid reservoir 120 at a distal end 121 of fluid reservoir. At proximal end 122 of fluid reservoir 120, a triggering mechanism 150 can be attached. In the illustrated embodiment, triggering mechanism 150 includes a dispensing button 160 and a spray tip 170, although other suitable triggering mechanisms may be used. Triggering mechanism 150 can be securely coupled to fluid reservoir 120 in any suitable manner, and may be frictionally fit thereto. Although not illustrated, cleaning device 100, when assembled, may include a cap such as that illustrated in FIGS. 1 and 2 with respect to cleaning device 10.

FIG. 6 illustrates an exemplary manner in which fluid reservoir 120 may operate to dispense cleaning fluid. In particular, fluid reservoir includes a hollow shell 123 into which the fluid is contained. At proximal end 122 of shell 123, an aperture is formed and a delivery tube 124 is inserted therein. Delivery tube 124 extends into fluid reservoir 120 and is in fluid communication with the cleaning fluid contained therein.

Delivery tube 124 may be configured such that the contents of shell 123 remain in shell 123 and are not released therefrom through delivery tube 124 until desired by a user. For example, a diaphragm (not shown) may be connected to delivery tube 124 within shell 123, and may create a seal which prevents the cleaning fluid within pressurized fluid reservoir 120 from escaping through delivery tube 124. In this manner, the natural position of delivery tube 124 is biased so that the pressurized fluid in shell 123 is not released.

When the user wants to dispense the cleaning fluid, the user can exert a distally-directed force on the proximal end of delivery tube 124, thereby compressing it within shell 123. For example, dispensing button 160 may be coupled to delivery tube 124 such that when a user presses downward on dispensing button 160, delivery tube 124 is also compressed. This action can at least partially break the seal created by the diaphragm within shell 124, thereby releasing the pressurized contents through delivery tube 124.

When the cleaning fluid is released, it can escape through delivery tube 124 into chamber 172 of spray tip 170. Chamber 172 is formed, in this embodiment, by a substantially vertical wall 173 which defines the shape of chamber 172. Chamber 172 may, for example, have a circular configuration, or may have any other suitable shape.

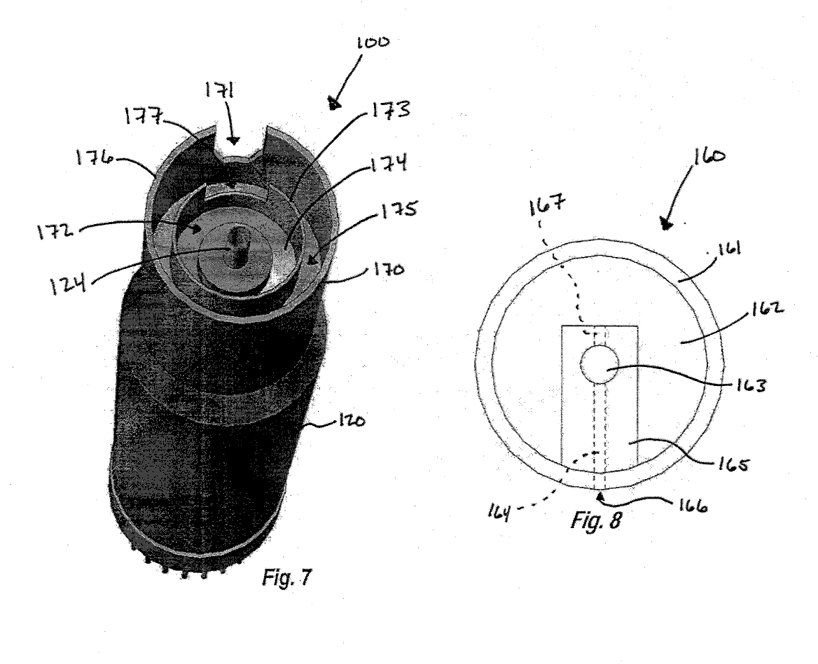

According to one embodiment, chamber 172 is enclosed on the distal end by a distal surface 174 of spray tip 170. Chamber 172 may also be enclosed on the proximal end by, for example, dispensing button 160 (FIG. 8). For example, and as illustrated in FIG. 7, a second chamber 175 may be formed between vertical wall 173 and outer wall 176 of spray tip 170. The outer wall 161 (FIG. 8) of dispensing button 160 may then fit within chamber 175. As dispensing button 160 is then depressed, the interior, top surface 162 (FIG. 8) of dispensing button 160 can contact the top surface of wall 173, thereby substantially enclosing chamber 172.

Referring now to FIG. 8, dispensing button 160 includes a recess 163 which receives delivery tube 124 (FIG. 7). As dispensing button 160 is then depressed downward, delivery tube 124 can move within recess 163 and engage a surface that then compresses delivery tube 124, thereby allowing cleaning fluid to be released from the pressurized fluid reservoir. According to one embodiment, when the cleaning fluid is released, the fluid is directed through recess 163, and through a channel 164 in a channel block 165. Channel 164 can lead to a nozzle 166 through which the cleaning fluid is dispensed to ambient. The nozzle 166 is optionally aligned with an opening 171 (FIG. 7) in spray tip 170 to allow the cleaning fluid to be dispensed to ambient. Opening 171 is, in this embodiment, a slot formed in the outer wall 176 of spray tip 171, although opening 171 may, in other embodiments, be a hole or other type of opening, aperture, or recess. In this manner, a user can dispense as much fluid as desired. For example, the user can maintain the dispenser button 160 in an engaged position and cleaning fluid will continue to be dispensed through dispenser button 160 until the user either disengages dispenser button 160, or until the cleaning fluid is emptied from the fluid reservoir.

According to an alternative embodiment, it is desirable to limit the amount of cleaning fluid released at a single time. For example, a cleaning device may be configured to release only a particular quantity of fluid that has been predetermined to be the amount necessary to clean a particular object may be fluid may be released.

FIGS. 7 and 8 further illustrates a dispensing button which has been configured to facilitate regulating and metering of the amount of fluid dispensed by the cleaning device 100 in a particular engagement of the triggering mechanism 50 (FIG. 6). For example, FIG. 7 illustrates chamber 172 which may substantially enclosed when dispensing button 170 is depressed. When depressed, the cleaning fluid from fluid reservoir 120 can pass through the delivery tube 124 housed within recess 163 in dispensing button 170. According to one embodiment, when dispensing button 170 is at least partially depressed, including when dispensing button 170 is fully depressed, delivery tube 124 may block the fluid from entering into channel 164 leading to nozzle 166. Delivery block 165 may then include a release channel 167 through which the cleaning fluid is passed. Release channel 167 may lead to the interior of chamber 172.

As the user continues to depress dispensing button 170, the cleaning fluid released from fluid reservoir 120 accumulates within chamber 172 formed in spray tip 170. In one embodiment, chamber 172 is sealed when dispensing button 170 is depressed. For example, a seal may be formed between wall 173 and dispensing button 170 to maintain fluid within chamber 172. In one embodiment, an opening 177 may be formed in vertical wall 173 to accommodate channel block 165 of dispensing button 160, in which case a seal may also be formed between the surfaces around opening 177 and channel block 165.

Any suitable sealing mechanism known in the art may be utilized to create the one or more seals. For example, according to one embodiment, the material used to form walls 161 and 173, and/or channel block 165 can create a fluid seal to maintain the pressurized fluid within chamber 172. In other embodiments, O-rings, gaskets, sealing flanges, or the like may be used.

In one embodiment, the seals maintain their integrity when the pressurized fluid has fully filled chamber 172. In such an embodiment, the pressurized cleaning fluid in chamber 172 thereby prevents additional cleaning fluid from being released from fluid reservoir 120. As disclosed herein, the amount of cleaning fluid to be dispensed may be controlled in a predetermined manner. In one embodiment, chamber 172 is sized such that it contains about the amount of cleaning fluid desired to be dispensed. In another embodiment, the chamber 172 is sized such that, the amount of fluid in chamber 172, combined with the fluid that is contained within delivery tube 124, but which has already passed the valve or diaphragm, is about equal to the predetermined amount. In this manner, when dispensing button 160 is released, thereby opening channel 164, the pressurized fluid in chamber 172, and optionally within a portion of delivery tube 124, passes through recess 163 and/or release channel 167, where it can be directed to nozzle 166.

In this manner, dispensing button 160 and spray tip 170 act as a regulator that controls the amount of fluid released. In particular, rather than continuing to dispense cleansing fluid as long as dispensing button 160 is engaged, dispensing button 160 and spray tip 170 act to dispense only a maximum amount of fluid regardless of the duration of time dispensing button 160 is engaged. Specifically, each time dispensing button 160 is engaged, and even if dispensing button 160 remains engaged and the valve in fluid reservoir 120 remains open, once chamber 163 is filled, little to no additional fluid will be released from fluid reservoir 120 and dispensed through nozzle 166. When additional cleaning fluid is desired, the user can then re-engage dispensing button 160 and about the same predetermined amount of cleaning fluid will be dispensed to the user upon disengagement of dispensing button 160. Thus, spray tip 170 and dispensing button 160 can collectively act as a valve for releasing cleaning fluid.

As will be appreciated in view of the disclosure herein, cleaning device 100, including triggering mechanism 150, can be sized and configured in a manner to release any predetermined amount of fluid desired. The amount of fluid desired can vary based on any of a number of factors. For instance, the amount of fluid can vary based on the size (e.g., surface area) of the object to be cleaned, the type of cleaning fluid being used, the amount of debris to be removed, or on any number of other criteria. For example, according to one embodiment, it has been determined that dispensing between about two milliliters and about five milliliters of cleaning fluid is sufficient to clean a golf ball. In another embodiment, a range of about two milliliters to about three milliliters may be sufficient. For example, chamber 172 may be sized so as to dispense about two-and-a-half milliliters each time dispensing button 160 is engaged and chamber 172 is filled fully with cleaning fluid.

It will also be appreciated that in other embodiments, a cleaning device according to aspects of the present invention may be developed and implemented to accommodate for dispensing different predetermined amounts of cleaning fluid. For example, according to one embodiment, a chamber that receives fluid released from the fluid reservoir, and before the fluid is dispensed to ambient, is partitioned into sections of two different sizes. A user may, for example, rotate a dispensing cap one-hundred eighty degrees to change between chambers. Furthermore, a visual indicator may be provided to indicate the difference in the amount of fluid that will be dispensed. For example, a numeric indicator may indicate the predetermined amount to be dispensed at each location. Alternatively, an image depicting the object to be cleaned with the predetermined amount may be indicated. For instance, a first chamber may be used when a nozzle is aligned with a picture of a golf ball, and the amount of cleaning fluid released may be that determined to be sufficient, if not optimal, for a golf ball. By rotating the dispensing cap, the nozzle may alternatively be aligned with a picture of a golf club, thereby indicating that the amount of fluid dispensed through the second chamber is that determined as sufficient for a golf club. Naturally, other visual indicators may be used. For example, each of two or more visual indicators may illustrate a golf ball in varying degrees of filth.

While the example embodiments disclosed herein have been described with respect to the particular embodiments illustrated in the attached drawings, it will be appreciated that the figures and description herein are exemplary only and not limiting of the present invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A cleaning device, comprising:
a fluid reservoir;
a valve in fluid communication with the fluid reservoir, said valve being configured to release cleaning fluid contained within said fluid reservoir when said valve is engaged; and
a regulator coupled to said valve and said fluid reservoir, said regulator being configured to dispense a predetermined amount of cleaning fluid from said fluid reservoir in a single engagement of said valve.

2. A cleaning device as recited in claim 1, wherein said regulator comprises an enclosed chamber, said enclosed chamber being sized to contain up to said predetermined amount of cleaning fluid.

3. A cleaning device as recited in claim 1, wherein said predetermined amount of cleaning fluid is a maximum amount of cleaning fluid, such that said regulator prevents said valve from dispensing an amount of cleaning fluid over said maximum amount of cleaning fluid.

4. A cleaning device as recited in claim 3, wherein said maximum amount of cleaning fluid is within a range of about 2 ml to about 5 ml.

5. A cleaning device as recited in claim 3, wherein said maximum amount of cleaning fluid is within a range of about 2 ml to about 3 ml.

6. A cleaning device as recited in claim 1, wherein said fluid reservoir includes a release, and wherein said valve comprises:
a spray tip coupled to said fluid reservoir; and
a nozzle engaging said release.

7. A cleaning device as recited in claim 1, further comprising:
an agitator coupled to said fluid reservoir.

8. A cleaning device as recited in claim 8, wherein said agitator comprises a brush.

9. A device for cleaning golf equipment, comprising:
a reservoir storing a quantity of cleaning fluid, said reservoir including a selectively engageable release for releasing said cleaning fluid from said reservoir; and
a regulator coupled with said selectively engageable release, said regulator being configured to limit the amount of cleaning fluid released from said reservoir in a single engagement of said release to a predetermined amount of cleaning fluid that is less than said quantity of cleaning fluid stored in said reservoir.

10. A device for cleaning golf equipment as recited in claim 9, wherein said regulator includes a chamber adapted to receive cleaning fluid released from said reservoir, prior to said cleaning fluid being released into ambient, said chamber being preconfigured to contain only said predetermined amount of cleaning fluid.

11. A device for cleaning golf equipment as recited in claim 10, wherein said regulator is configured such that when said release is engaged, said predetermined amount of cleaning fluid is released into said chamber.

12. A device for cleaning golf equipment as recited in claim 11, wherein said regulator is further configured such that when said chamber is filled with said predetermined amount of cleaning fluid, additional cleaning fluid in excess of said predetermined amount of cleaning fluid is prevented from being released from said reservoir, even where said release continues to be engaged.

13. A device for cleaning golf equipment as recited in claim 11, wherein said regulator is further configured such that when said release is disengaged, said cleaning fluid in said chamber is dispensed into ambient.

14. A device for cleaning golf equipment as recited in claim 9, further comprising:
a nozzle in fluid communication with said regulator, said nozzle being adapted to dispense said released cleaning fluid.

15. A device for cleaning golf equipment as recited in claim 9, further comprising a brush coupled to said reservoir.

16. A device for cleaning golf equipment as recited in claim 15, wherein said regulator is configured to dispense said predetermined amount of cleaning fluid onto golf equipment, and wherein said brush is contoured to complement a shape of said golf equipment so as to agitate dirt and remove said dirt from said golf equipment.

17. An device for cleaning a golf ball, comprising:
a cleaning fluid release assembly, comprising:
a reservoir storing pressurized cleaning fluid, said reservoir having a valve for releasing said pressurized cleaning fluid from said reservoir;
a trigger coupled to said valve, said trigger being adapted such that when said trigger is engaged, said trigger causes said valve to release said pressurized cleaning fluid from said reservoir; and
a mechanism for dispensing a predetermined amount of cleaning fluid when said trigger causes release of said pressurized cleaning fluid, said mechanism for dispensing a predetermined amount of cleaning fluid including an enclosed chamber, external to said reservoir, for containing up to said predetermined amount of cleaning fluid when said cleaning fluid is released from said reservoir; and
a cleaning brush coupled to said cleaning fluid release assembly, said cleaning brush being configured for at least partially receiving an outer surface of a golf ball.

18. A device as recited in claim 17, wherein said predetermined amount of cleaning fluid is within a range of about 2 ml to about 5 ml.

19. A device as recited in claim 17, wherein said device further comprises:
a selectively detachable cap coupled to said cleaning fluid release assembly.

20. A device as recited in claim 17, wherein said cleaning brush comprises a plurality of bristles, and wherein said plurality of bristles are collectively contoured to compliment said outer surface of said golf ball.
